(19) United States
(12) Patent Application Publication
(10) Pub. No.: US 2026/0106535 A1
(43) Pub. Date: Apr. 16, 2026

(54) MITIGATION OF CIRCULATING CURRENTS IN PARALLELED POWER CONVERTERS HAVING INDEPENDENT DC LINKS

(71) Applicant: Eaton Intelligent Power Limited, Dublin (IE)

(72) Inventors: Hua Qiang Li, Menomonee Falls, WI (US); Wenxi Yao, Hangzhou (CN); Zhihao Song, Hangzhou (CN)

(21) Appl. No.: 18/917,200

(22) Filed: Oct. 16, 2024

(51) Int. Cl. H02M 1/12; H02M 1/00; H02M 5/458

(52) U.S. Cl. CPC H02M 1/12; H02M 1/0019; H02M 5/458

(57) ABSTRACT

A system includes: an adjustable speed drive (ASD) module including an input, an output, and a plurality of ASDs in parallel, each ASD including: a rectifier electrically connected to the input of the ASD module; an inverter electrically connected to the output of the ASD module, the inverter including a plurality of controllable switches configured to switch at a switching frequency; and a direct current (DC) link electrically connected to the rectifier and the inverter; and a control system coupled to the ASD module, the control system configured to compensate for a plurality of circulating currents.

### TECHNICAL FIELD

This disclosure relates to mitigation of circulating currents in paralleled power converters having independent DC links.

### BACKGROUND

An electrical apparatus, such as a variable speed drive (VSD), an adjustable speed drive (ASD), or an uninterruptable power supply, may be connected to an alternating current (AC) high-power electrical distribution system, such as a power grid. The electrical apparatus drives, powers, and/or controls a machine, or a non-machine type of load and can also convert direct current (DC) power to AC power. The source of DC power can be, for example, energy storage, batteries, photovoltaic (PV) solar and/or other renewable sources, or another AC to DC power converter. The electrical apparatus includes an electrical network that converts AC power to direct-current (DC) power and may also convert DC power to AC power.

### SUMMARY

In one aspect, a system includes: an adjustable speed drive (ASD) module including an input, an output, and a plurality of ASDs in parallel, each ASD including: a rectifier electrically connected to the input of the ASD module; an inverter electrically connected to the output of the ASD module, the inverter including a plurality of controllable switches configured to switch at a switching frequency; and a direct current (DC) link electrically connected to the rectifier and the inverter; and a control system coupled to the ASD module, the control system configured to compensate for a plurality of circulating currents.

Implementations may include one or more of the following features.

The plurality of circulating currents may include a circulating current associated with the switching frequency and a circulating current associated with an operating speed of a load electrically connected to the ASD module. To compensate for the circulating current associated with the switching frequency, the control system may be configured to minimize a difference in an electrical quantity output by the inverter of each of the plurality of ASDs. The electrical quantity may be a β-axis output current. To compensate for the circulating current associated with the switching frequency, the control system may be configured to adjust a phase of a carrier frequency of at least one of the inverters. To compensate for the circulating current associated with the operating speed of the load, the control system may be configured to minimize a difference in an observed o-axis current.

In another aspect, a control apparatus includes: a cross-circulating current compensation module configured to: access a measured value of an electrical quantity at each of a plurality of inverters, each of the plurality of inverters is electrically connected to an independent DC link; determine a difference between the accessed measured values; determine a compensation based on the determined difference; and adjust a carrier wave of one or more of the plurality of inverters based on the determined compensation.

Implementations may include one or more of the following features.

To determine a difference between the measured values, the cross-circulating current compensation module may be configured to determine a difference between a β-axis component of an output current of each of the plurality of inverters.

The compensation may include a phase shift, and to adjust the carrier wave of one or more of the plurality of inverters, the cross-circulating current compensation module may be configured to delay or advance the carrier wave of one or more of the plurality of inverters by the phase shift.

The control apparatus also may include an operating frequency circulating current compensation module configured to reduce an amount of circulating current at an operating frequency of a load electrically connected to the plurality of inverters.

The cross-circulating current compensation module also may be configured to minimize the difference between the accessed measured values and to determine the compensation based on the minimized difference.

In another aspect, a method includes accessing a measured value of an electrical quantity at an output of each of a plurality of inverters, each of the plurality of inverters is electrically connected to an independent DC link; determining a difference between the accessed measured values; determining a compensation based on minimizing the difference between the accessed measured values; adjusting a control signal for one or more of the plurality of inverters based on the compensation; and providing the adjusted control signal to the one or more of the plurality of inverters to equalize the electrical quantity at the outputs of the inverters and the voltage across the independent DC links.

In some implementations, the electrical quantity includes a three-phase current at an output of each of the plurality of inverters, and, after providing the adjusted control signal to the one or more of the plurality of inverters, any one phase of the three-phase output current at a first one of the plurality of inverters is substantially the same in amplitude and phase as that same one phase at any other of the plurality of inverters.

Implementations of any of the techniques described herein may include an apparatus, a device, a system, a control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power system.

FIG. 2 is a schematic of an example of a system.

FIG. 3A is a block diagram of an example of a control scheme.

FIG. 3B which is a representation of a coordinate system.

FIG. 4 is a graphical example of switching events as a function of time in the b-phase and c-phase of two parallel connected inverters that each have an independent DC link.

FIG. 5 shows an example of uncompensated cross-circulating current.

FIG. 6 is a block diagram of an example of a compensation block.

FIG. 7A shows an example of DC link voltage of first and second ASDs as a function of time.

FIG. 7B shows an example of output phase current of first and second inverters over time.

FIG. 8 shows a simulation of applying the control scheme of FIG. 3A to compensate for circulating current.

### DETAILED DESCRIPTION

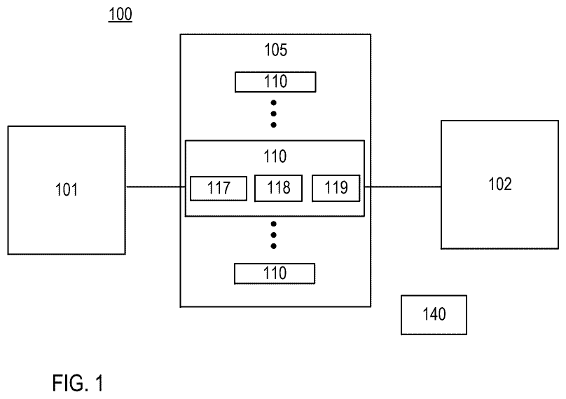

FIG. 1 is a block diagram of an example of a power system 100. The power system 100 includes a drive apparatus 105 that is electrically connected to a source 101 and a load 102, and a control system 140. As discussed below, the control system 140 compensates for, mitigates, and/or eliminates circulating currents in the drive apparatus 105.

The load 102 is any type of device or system that utilizes, transfers, absorbs, or distributes time-varying (or AC) electricity. The load 102 may be, for example, a motor (such as an induction motor), a lighting system, a machine, or a generator. The load 102 may take other forms. For example, the load 102 may be an AC power grid, an AC to DC power converter, an AC to AC power converter, just to name a few. The source 101 is any type of source of alternating current (AC) or time-varying electrical power. For example, the source 101 may be a node in an AC power grid or distribution network, an AC generator, or an output of an AC electrical apparatus, such as a DC to AC power converter, a transformer, or a voltage regulator.

The drive apparatus 105 includes N power converters 110, where N is a positive number that is equal to or greater than two. Each of the N power converters 110 may be, for example, an adjustable speed drive (ASD). The N power converters 110 are connected in parallel and each of the N power converters 110 includes a respective direct current (DC) link 118. The DC links 118 are any type of device that is capable of storing electrical energy. For example, each DC link 118 may be one or more capacitors. Each of the N power converters 110 also includes a rectifier 117 and an inverter 119. Each inverter 119 includes a plurality of controllable semiconductor switches, each of which may be, for example, an insulated gate bipolar transistor (IGBT) or a metal-oxide-semiconductor field-effect transistor (MOSFET). Additionally, each inverter 119 includes an inductor at the output.

Connecting the N power converters 110 in parallel promotes modularity and redundancy. For example, if one of the N power converters 110 fails, the remaining power converters 110 continue to power the load 102 until the failed power converter is repaired or replaced. Additionally, the drive apparatus 105 delivers more power than a single power converter. Furthermore, including an independent DC link 118 in each of the N power converters 110 eliminates busbars and/or other high current capacity connections that would otherwise be used to connect power converters that lack a dedicated DC link 118 to a shared DC link.

Although all of the N power converters 110 are identical, the parameters of the N power converters 110 are not exactly the same. This is due to, for example, differences in the components of the N power converters 110 that arise during manufacture and/or assembly. For example, the controllable semiconductor switches in the inverters 119 have a rise time and fall time. Although all of the semiconductor switches are nominally the same, the rise time and fall time of the individual switches vary to within the manufacturing tolerance of the switch. Thus, although all of the inverters 119 are nominally identical, in practice, some or all of the controllable semiconductor switches in the various inverters 119 may have different a rise and/or fall time. Other parameters that may vary among the N power converters 110 include, without limitation, pulse with modulation (PWM) phase shift, deadtime, and inductance of the output inductor.

Due to these variations, circulating currents may exist at the frequency of operation of the load 102 and at the inverter 119 switching frequency. The circulating current may overcharge the DC links 118, shortening the lifetime of the DC links 118 and/or causing reliability and performance issues. On the other hand, the control system 140 causes the controllable semiconductor switches to change state or switch in a manner that reduces or eliminates the circulating current at both the load operating frequency and at the inverter switching frequency. In this way, the control system 140 improves the overall performance of the drive apparatus 105 and the system 100.

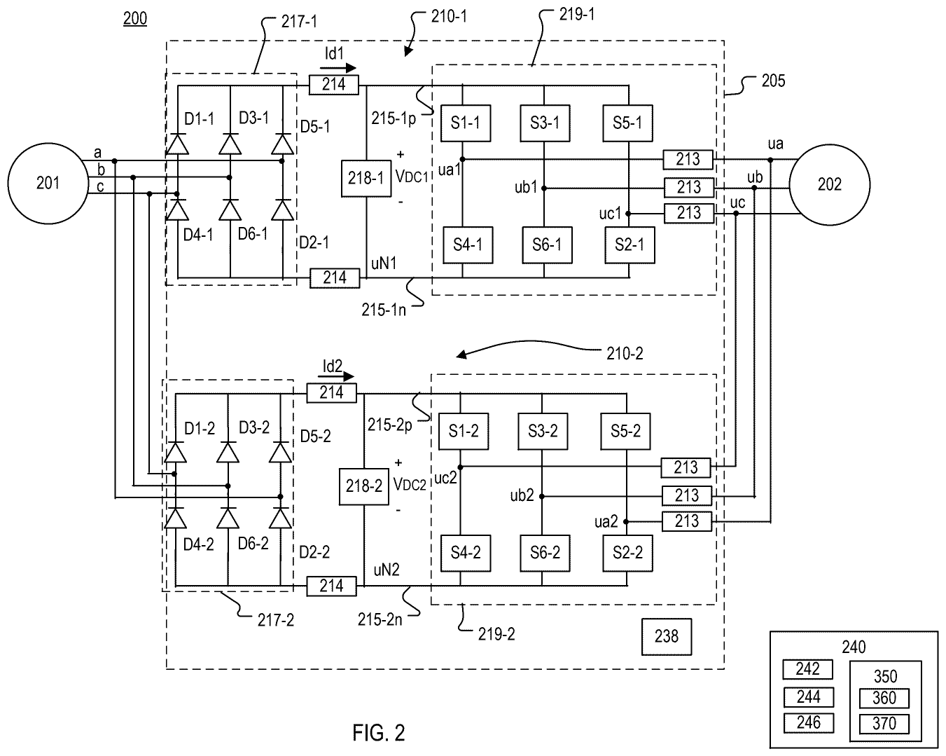

FIG. 2 is a schematic of a system 200. The system 200 includes a drive apparatus 205 that is connected to a three-phase AC electrical power source 201 and to a three-phase load 202. The drive apparatus 205 includes a first power converter 210-1 connected in parallel with a second power converter 210-2. The first and second power converters 210-1 and 210-2 may be, for example, identical ASDs. The first power converter 210-1 includes a rectifier 217-1, an inverter 219-1, and a DC link 218-1 electrically connected to the rectifier 217-1 and the inverter 219-1. The second power converter 210-2 includes a rectifier 217-2, an inverter 219-2, and a DC link 218-2 electrically connected to the rectifier 217-2 and the inverter 219-2. The power converter 210-1 includes a positive DC bus 215-1p and a negative DC bus 215-1n. The power converter 210-2 includes a positive DC bus 215-2p and a negative DC bus 215-2n.

The system 200 also includes a control system 240 that controls the inverters 219-1 and 219-2 based on a control scheme 350. The control scheme 350 includes an operating frequency module 360, which mitigates circulating currents at the operating frequency of the load 202, and a switching frequency module 370, which mitigates circulating currents at the switching frequency of the inverters 219-1 and 219-2.

An overview of the system 200 is provided prior to discussing the control scheme 350 in more detail.

The load 202 is any three-phase load. For example, the load 202 may be a three-phase motor, such as an induction motor or a permanent magnet synchronous machine, an AC power grid, an AC-to-DC power converter, or an AC-to-AC power converter, just to name a few. The source 201 is a three-phase source with phases a, b, c. For example, the source 201 may be a node in an electrical power distribution network that distributes three-phase AC electrical power having a fundamental frequency of, for example, 50 or 60 Hertz (Hz). The distribution network may have an operating voltage of up to 690V. The distribution network may include, for example, one or more transmission lines, distribution lines, electrical cables, and/or any other mechanism for transmitting electricity. The source 201 may take other forms. For example, the source 201 may be a generator, a renewable energy resource, or a transformer.

The rectifier 217-1 is a three-phase six-pulse bridge that includes six electronic switches. In the example of FIG. 2, the six electronic switches are diodes D1-1 to D6-1. Each diode D1-1 to D6-1 includes a cathode and an anode and is associated with a forward bias voltage. Current can flow through a diode in the forward direction (from the anode to the cathode) when the voltage of the anode is greater than the voltage of the cathode by at least the bias voltage. When the voltage difference between the anode and the cathode is less than the forward bias voltage, the diode does not conduct current in the forward direction.

Phase a of the source 201 is electrically connected to the anode of the diode D1-1 and the cathode of the diode D4-1. Phase b of the source 201 is electrically connected to the anode of the diode D3-1 and the cathode of the diode D6-1. Phase c of the source 201 is electrically connected to the anode of the diode D5-1 and the cathode of the diode D2-1. The diodes D1-1 to D6-1 rectify the AC input currents ia, ib, ic from the source 201 into a DC current id1.

The diodes D1-1 to D6-1 are also electrically connected to the DC link 218-1 through choke inductors 214. The DC link 218-1 includes one or more devices that are configured to store electrical energy. For example, the DC link 218-1 may be a capacitor or a network of capacitors. The inverter 219 converts the DC power stored in the DC link 218-1 into three-phase AC voltage (ua1, ua2, ua3) that is available for the load 202. The inverter 219 includes a network of electronic switches S1-1 to S6-1 that are controlled by the control system 240 to generate the AC voltages. Each of the switches S1-1 to S6-1 may be, for example, a power transistor. The power converters 210-1 and 210-2 are identical, and the power converter 210-2 is configured in the same manner as the power converter 210-1.

Each phase of the output of the inverter 219-1 and the inverter 219-2 is connected to one phase of the load 202 through a respective output inductor 213.

The system 200 also includes a sensor system 238 that measures and/or estimates properties or parameters. For example, the sensor system 238 may include current sensors that measure the amount of current drawn in each phase of the load 202, the currents at the outputs of the inverters 219-1 and 219-2, voltage sensors that measure the voltages ua1, ub1, uc1 at the output of the inverter 219-1 and the voltages ua2, ub2, uc2 at the output of the inverter 219-2, and/or voltage sensors that measure the voltage across each DC link 218-1, 218-2. The system 200 may include other components and features. For example, each power converter 210-1, 210-2 may include an L-C or L-C-L filter between the respective rectifier 217-1, 217-2 and the source 201.

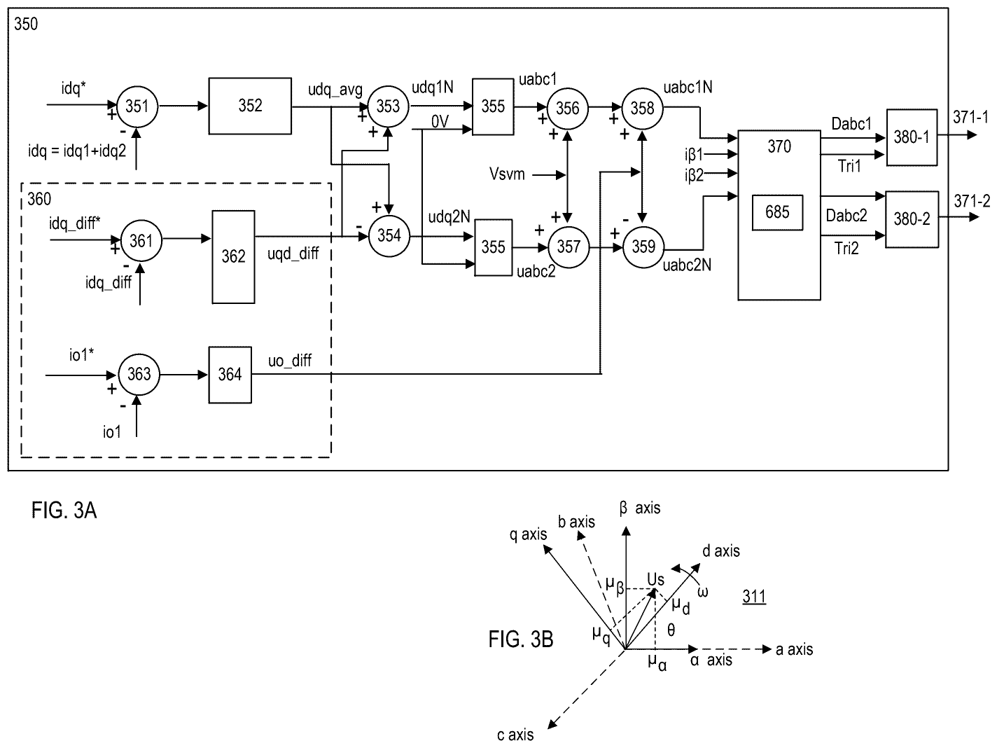

The control system 240 controls the switching pattern of the switches S1-1 to S6-1 and the switches S1-2 to S6-2 to generate respective AC voltages ua1, ub1, uc1 and ua2, ub2, uc2 with particular characteristics (for example, amplitude, frequency, and/or phase). The control system 240 implements the control scheme 350, which is discussed with respect to FIG. 3A.

The control system 240 includes an electronic processing module 242, an electronic storage 244, and an input/output (I/O) interface 246. The electronic processing module 242 includes one or more electronic processors. The electronic processors of the module 242 may be any type of electronic processor and may or may not include a general-purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 244 may be any type of electronic memory that is capable of storing data and instructions in the form of computer programs or software, and the electronic storage 244 may include volatile and/or non-volatile components. The electronic storage 244 and the processing module 242 are coupled such that the processing module 242 is able to access or read data from and write data to the electronic storage 244. The electronic storage 244 stores instructions that, when executed, cause the electronic processing module 242 to analyze data and/or retrieve information. The electronic storage 244 includes executable instructions to implement various transformations, such as, for example, the Clarke transformation, the Park transformation, and inverse versions of these transformations. Additionally, the electronic storage 244 stores executable instructions that implement the control scheme 350 and the modules 360 and 370 as software, subroutines, functions, or computer programs.

The I/O interface 246 may be any interface that allows a human operator and/or an autonomous process to interact with the control system 240. The I/O interface 246 may include, for example, a display (such as a liquid crystal display (LCD)), a keyboard, audio input and/or output (such as speakers and/or a microphone), visual output (such as lights, light emitting diodes (LED)) that are in addition to or instead of the display, serial or parallel port, a Universal Serial Bus (USB) connection, and/or any type of network interface, such as, for example, Ethernet. The I/O interface 246 also may allow communication without physical contact through, for example, an IEEE 802.11, Bluetooth, or a near-field communication (NFC) connection. The control system 240 may be, for example, operated, configured, modified, or updated through the I/O interface 246.

The I/O interface 246 also may allow the control system 230 to communicate with components in the system 200 and with systems external to and remote from the system 200. For example, the I/O interface 246 may control a switch or a switching network (not shown) or a breaker within the system 200 that allows the electrical apparatus 210 to be disconnected from the source 201. In another example, the I/O interface 246 may include a communications interface that allows communication between the control system 240 and a remote station (not shown), or between the control system 240 and a separate monitoring apparatus. The remote station or the monitoring apparatus may be any type of station through which an operator is able to communicate with the control system 240 without making physical contact with the control system 240. For example, the remote station may be a computer-based work station, a smart phone, tablet, or a laptop computer that connects to the control system 240 via a services protocol, or a remote control that connects to the control system 240 via a radio-frequency signal.

In operational use of the system 200, two types of circulating currents can flow in the drive apparatus 205. The first type of circulating current is a zero-sequence circulating current that flows through the inverters 219-1 and 219-2 and the rectifiers 217-1 and 217-2. The zero-sequence circulating current occurs at the operating frequency of the load 202. In other words, the zero-sequence circulating current is an AC current that includes a frequency component at or near the operating frequency of the load 202. The operating frequency of the load may be, for example, up to 400 Hz. The second type of circulating current is a cross-circulating current that occurs between different phases and flows through the DC link 218-1 or the DC link 218-2. For example, the cross-circulating current may flow through the switch S4-2 and into the switches S6-2 and S2-2, into the switches S6-1 and S2-1, into the DC link 218-1, and into the switch S1-1. This cross-circulating current can overcharge the DC link 218-1, reducing the lifetime of the DC link 218-1 and the power converter 210-1. The cross-circulating current occurs at the switching frequency of the inverters 219-1 and 219-2 and is generally a much higher frequency than the zero-sequence circulating current. For example, the switching frequency of the inverters 219-1 and 219-2 may be 4 kHz.

FIG. 3A is a block diagram of the control scheme 350. The sensor system 238 measures the current or voltage at the output of each phase in the inverters 219-1 and 219-2. The phase currents at the output of the inverter 219-1 are ia1, ib1, and ic1 and the phase currents at the output of the inverter 219-2 are ia2, ib2, and ic2. Referring also to FIG. 3B, which is a representation 311, the phase currents at the output of each of the inverter 219-1 (ia1, ia1, ia1) and the inverter 219-2 (ia2, ib2, ic2) are transformed into two orthogonal current components: a component iα along the α axis and a component iβ along the β axis (which is orthogonal to the α axis) using the Clarke transformation. The Clark transformation projects a three-phase quantity (such as a three-phase current or voltage) onto a two-dimensional stationary coordinate system defined by the α axis and the β axis. The Clark transformation is shown in Equation (1):

$${i}_{αβ o} = \frac{2}{3} [ \begin{matrix}1 & - \frac{1}{2} & - \frac{1}{2} \\ 0 & \frac{\sqrt{3}}{2} & - \frac{\sqrt{3}}{2} \\ \frac{1}{2} & \frac{1}{2} & \frac{1}{2}\end{matrix} ] [ \begin{matrix}{i}_{a} \\ {i}_{b} \\ {i}_{c}\end{matrix} ] , \qquad Equation ( 1 )$$

where ia, ib, ic are the instantaneous currents output by the inverter 219-1 or 219-2, and i_{αβ} is a vector that includes a component along the α axis and a component along the β axis. The vector also includes an o-axis component that is zero when the current is balanced in all three phases a, b, c. The current is balanced when each phase a, b, c, has the same amplitude and each phase a, b, c is 120° out of phase with the other phases.

The vector i_{αβo} is transformed into dq coordinates by the Park transformation. The Park transformation is shown in Equation (2):

$$idqo = [ \begin{matrix}id \\ iq \\ io\end{matrix} ] = [ \begin{matrix}cos ( θ ) & sin ( θ ) & 0 \\ - sin ( θ ) & cos ( θ ) & 0 \\ 0 & 0 & 1\end{matrix} ] [ \begin{matrix}i α \\ i β \\ i o\end{matrix} ] , \qquad Equation ( 2 )$$

where idqo is a vector that includes a component along the d axis (id, or the observed d-axis current), a component along the q axis (iq, or the observed q-axis current), and an o-axis component (io), and θ is the observed angular position (θo) of the load 202. For example, in implementations in which the load 202 is a motor, the observed angular position (θo) is the position of the rotor. The idq vector represents an observed output current with a component on the d-axis and a component on the q-axis and is determined for the inverter 219-1 (idq1) and for the second inverter 219-2 (idq2).

To control the current to the load 202, the target output inverter current (idq*) for the load 202 is compared to the observed current (idq) output by the drive apparatus 205. The observed current (idq) is the sum of the observed output of the inverter 219-1 (idq1) and the observed output of the inverter 219-2 (idq2), as shown in Equation (3):

$$i d q = i d q 1 + i d q 2 . \qquad Equation ( 3 )$$

The target inverter output current (idq*) is compared to the observed inverter output current (idq) at a summation junction 351, which subtracts idq from idq*. The output of the summation junction 351 is Δidq, which is the difference between the target current (idq*) and the observed current (idq). The output of the summation junction 351 (Δidq) is provided to a proportional-integral (PI) controller 352 that has a pre-determined gain constant. The PI controller 352 minimizes Δidq and outputs the average inverter output voltage (udq_avg), which is used to control the three-phase current to the load 202.

As discussed above, circulating currents also flow in the power converters 210-1, 210-2. The circulating currents may negatively impact performance of the system 200 and the control scheme 350 reduces, eliminates, or compensates for the circulating current. The circulating currents do not flow into the load 202 and thus are controlled separately from the three-phase current to the load 202. The circulating current at the operating frequency of the load 202 includes a dq-axis circulating current and an o-axis circulating current. The operating frequency module 360 controls both of these components to zero.

The operating frequency module 360 includes a summation junction 361, which compares a target difference between the dq output current of the inverters 219-1 and 219-2 (idq_diff*) to the observed dq current difference (idq_diff) by subtracting idq_diff from idq_diff*. Under ideal conditions, the inverters 219-1 and 219-2 produce the same output current waveforms, there is no circulating current, and the difference between the dq output inverter current is 0. Thus, the target inverter current difference (idq_diff*) is set to zero. The observed inverter current difference (idq_diff) is determined by Equation 4:

$$idq\_diff = \frac{i d q 1 - i d q 2}{2} , \qquad Equation ( 4 )$$

where idq1 is the observed output current of the inverter 219-1 and idq2 is the observed output current of the inverter 219-1, 219-2. The summation junction 361 determines a difference between the target inverter current difference (idq_diff*) and the observed inverter current difference (idq_diff) and produces an error metric Δidq_diff, which is provided to a PI controller 362. The PI controller 362 has a predetermined gain constant and seeks to reduce the error metric Δidq_diff. The PI controller 362 outputs the inverter voltage difference (udq_diff).

The o-axis circulating current is also controlled to zero using a PI controller 364. The target o-axis circulating current (io*) is set to zero. The observed o-axis current (io1) is determined from the measured output current of the inverter 219-1 and Equation (5):

$$i o 1 = \frac{i a 1 + i b 1 + ic 1}{3} , \qquad Equation ( 5 )$$

where iα1, ib1, ic1 are the measured three-phase output currents of the inverter 219-1. The difference between the target o-axis current (io*) and the observed o-axis current (io1) is determined at a summing junction 363 to produce an error metric Δio, which is provided to the PI controller 364. The PI controller 364 minimizes the error metric Δio and produces uo_diff.

The average inverter output voltage (udq_avg) is provided to summation blocks 353 and 354 to determine (udq1N) and (udq2N), respectively. The summation block 353 determines udq1N based on the sum of (udq_avg) and (Udq_diff). The summation block 354 determines udq2N based on (udq_avg-udq_diff).

Each of (udq1N) and (udq2N) are provided to a transformation block 355, which implements an inverse of the Park transformation and an inverse of the Clarke transformation to determine the three-phase voltage (uabc1) at the inverter 219-1 and the three-phase voltage (uabc2) at the inverter 219-1. The respective three-phase voltages (uabc1) and (uabc2) are added to a space vector modulation voltage (Vsvm) at respective summation junctions 356, 357. The space vector modulation voltage (Vsvm) is a third harmonic voltage injected to boost the output voltage of the inverters 219-1 and 219-2. The output of the summation junction 356 is added to uo_diff at a summation junction 358 to produce uabc1N. The output of the summation junction 357 is provided to a summation junction 359, which subtracts uo_diff from uabc2 to produce uabc2N.

The output of each junction 358 and 359 is input into the switching frequency module 370 along with iβ1, which is the β-axis component of the output current of the first inverter 219-1, and iβ2, which is the β-axis component of the output current of the second inverter 219-2. The values of iβ1 and iβ2 may be obtained by converting data representing measured output current values of the inverters 219-1 and 219-2 from the sensor system 238 into components along the β axis.

The switching frequency module 370 accounts for and removes circulating current at the switching frequency of the inverters 219-1 and 219-2. The cross-circulating current is caused by asynchronous PWM switching events in the paralleled power converters 210-1 and 210-2. For example, the switch S1-1 in the inverter 219-1 may have a slower rise time than the switch S1-2 in the inverter 219-2 even though S1-1 and S1-2 are nominally the same kind of transistor. In this scenario, if the switch S1-1 and the switch S1-2 are commanded to turn ON at the same time, the switch S1-1 turns on after the switch S1-2 due to having a slower rise time and an asynchronous switching event has occurred. The switching frequency module 370 compensates the command 219-1 and/or 219-2 to mitigate or eliminate asynchronous switching events.

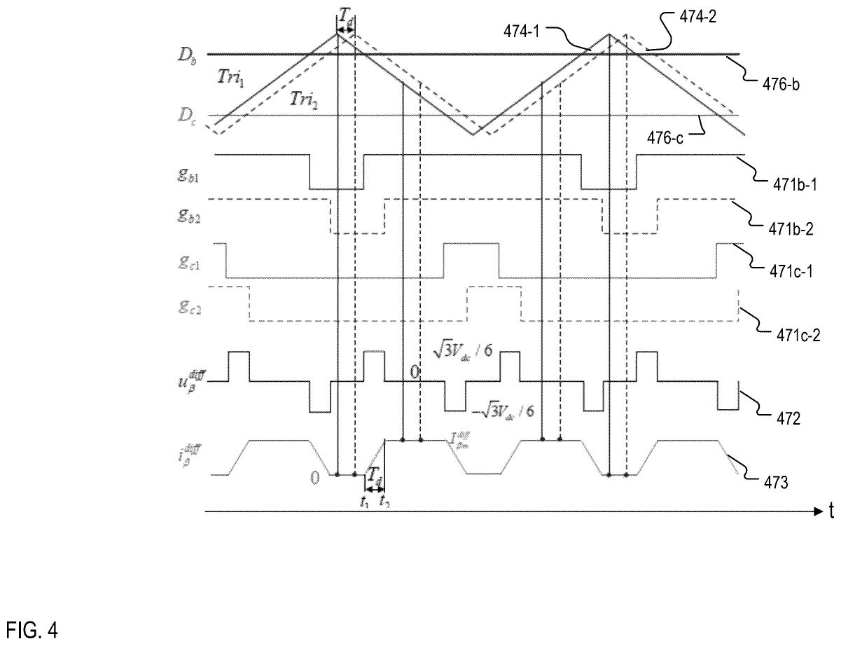

FIG. 4 is a graphical example of switching events as a function of time in the b-phase and c-phase of each inverter 219-1 and 219-2. FIG. 4 includes representations of an AC b-phase reference wave 476-b, an AC c-phase reference wave 476-c, a first inverter 219-1 carrier wave Tri1 474-1, and a second inverter 219-2 carrier wave Tri2 474-2. The carrier waves Tri1 474-1 and Tri2 474-2 are triangle waves having a fundamental frequency at the switching frequency of the inverters 219-1 and 219-2. The reference waves 476-b and 476-c vary over time at the operating frequency of the load 202. The operating frequency of the load 202 is much lower than the switching frequency of the controllable switches in the inverters 219-1 and 219-2. For example, the operating frequency of the load 202 may be 60 Hz and the switching frequency of the inverters 219-1, 219-2 may be 4 kHz. The time span shown in FIG. 4 is much less than one cycle of the load 202, and, thus, the b-phase reference wave 476-b and the c-phase reference wave 476-c have essentially constant values in FIG. 4. To provide a more specific example, one cycle of a load 202 operated at 60 Hz is 16.6 milliseconds (ms), whereas FIG. 4 shows about two cycles of the carrier waves Tri1 474-1, Tri2 474-2, and each cycle of the carrier waves Tri1 474-1, Tri2 474-2 may be about 250 microseconds (μs). Thus, although the amplitude of the references waves 476-b, 476-c varies over time, their amplitudes are constant over the time span shown in FIG. 4.

FIG. 4 also shows a gate command 471b-1 for the b-phase switch S3-1 in the first inverter 219-1, a gate command 471b-2 for the b-phase switch S3-2 in the second inverter 219-2, a gate command 471c-1 for the c-phase switch S5-1 in the first inverter 219-1, and a gate command 471c-2 for the c-phase switch S5-2 in the second inverter 219-2. Each of the gate commands 471b-1, 471b-2, 471c-1, 471c-2 is a digital voltage signal that corresponds to the state of the respective switch in that phase. For example, when the gate command 471b-1 is HIGH, the b-phase switch S3-1 is ON.

The intersection of the carrier wave Tri1 474-1 with the b-phase reference wave 476-b defines the gate command 471b-1. For example, the rightmost transition of the gate command 471b-1 corresponds in time with the intersection of the carrier wave Tri1 474-1 with the b-phase reference wave 476-b. The immediately subsequent transition of the gate command 471b-1 occurs when the carrier wave Tri1 474-1 intersects and falls below the b-phase reference wave 476-b. Similarly, the intersection of the carrier wave Tri2 474-2 with the b-phase reference wave 476-b defines the gate command 471b-2. For example, the rightmost transition of the gate command 471b-2 occurs when the carrier wave Tri2 474-2 intersects the b-phase reference wave 474-b. The immediately subsequent transition of the gate command 471b-2 occurs when the carrier wave Tri2 474-2 intersects and falls below the b-phase reference wave 476-b. The gate commands in the c-phase 471c-1, 471c-2 are defined by the intersection of the respective carrier wave Tri1 474-1, Tri2 474-2 with the c-phase reference wave 476-c.

In the example of FIG. 4, there is a delay (Td) between the carrier wave Tri1 474-1 and the carrier wave Tri2 474-2. The delay (Td) corresponds to a delay between the b-phase gate commands 471b-1, 471b-2 and between the c-phase gate commands 471c-1, 471c-2. During the time periods in which the gate commands for a particular phase are not synchronized, the output voltage and the output current of the inverters 219-1 and 219-2 is also unequal. As shown in FIG. 4, β-axis inverter output voltage difference 472 is non-zero at time periods that correspond to an amplitude difference between the gate commands 471c-1 and 471c-2 and at time periods that correspond to an amplitude difference between the gate commands 471b-1 and 471b-2. This causes the cross-circulating current, and FIG. 4 shows the β-axis component of the cross-circulating current (idiffβ=iβ1−iβ2) labeled as 473.

The switching frequency module 370 determines an inverter current difference in the β-axis and a time delay (Td) according to Equations (6) to (8):

$$idiffBm 1 = \frac{\sqrt{3} {V}_{D C} {T}_{d}}{6 {L}_{C S}} , {D}_{b} > {D}_{c} , \qquad Equation ( 6 )$$

$$idiffBm 2 = - \frac{\sqrt{3} {V}_{D C} {T}_{d}}{6 {L}_{C S}} , {D}_{b} < {D}_{c} , \qquad Equation ( 7 )$$

$$Td = - \frac{\sqrt{3} {L}_{C S}}{{V}_{D C}} ( IdiffBm 1 - IdiffBm 2 ) , \qquad Equation ( 8 )$$

where Db is the amplitude of the b-phase reference 476-b of the first inverter 219-1, Dc is the amplitude of the phase c reference 476-c of the first inverter 219-1, Les is the inductance of the output inductors 213, Td is the phase shift between Tri1 and Tri2, idiffBm1 is a positive peak of the β-axis component of the cross-circulating current (iβdiff) 473, and idiffBm2 is a negative peak of the β-axis component of the cross-circulating current (iβdiff) 473. The phase shift between Tri1 and Tri2 is a time delay between a point on Tri1 and a corresponding point on Tri2.

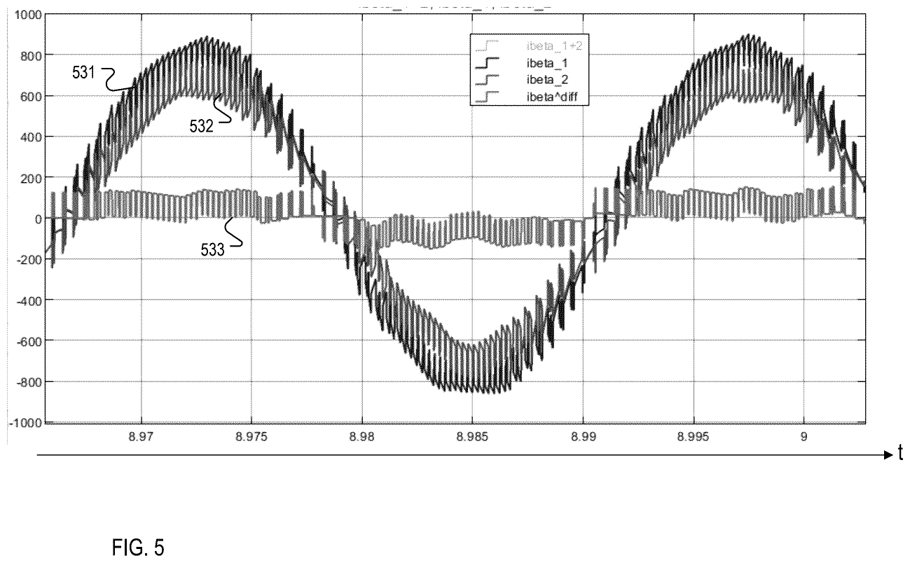

FIG. 5 shows an example of uncompensated cross-circulating current. In FIG. 5, current amplitude in amperes (A) is plotted as a function of time. The data shown in FIG. 5 was generated by simulating an induction motor operating at 80% rated speed and load. In FIG. 5, the current 531 is the β-axis output current of the inverter 219-1, the current 532 is the β-axis output current of the inverter 219-2, and the current 533 is the difference between the β-axis output currents. In the scenario depicted in FIG. 5, a cross-circulating current existed and IdiffBm1=127A and IdiffBm2=−127A.

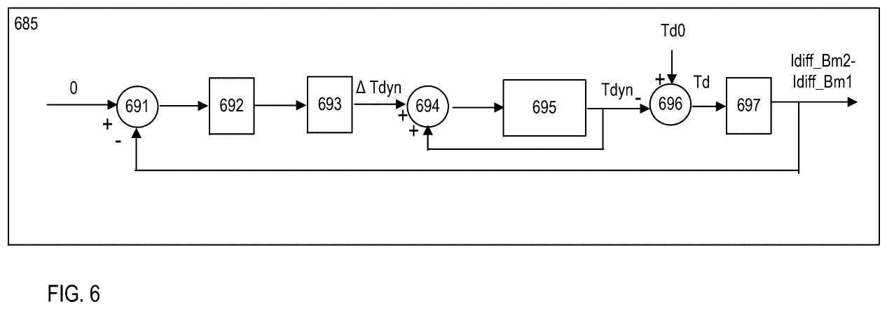

FIG. 6 is a block diagram of a compensation block 685 used in the switching frequency module 370. In the compensation block 685, Td0 is the time that the inverter carrier wave Tri2 474-2 lags behind the inverter carrier wave Tri1 474-1 before compensation, ΔTdyn is the time that the inverter carrier wave Tri1 474-1 lags behind the inverter carrier wave Tri2 474-2 after each compensation, Tdyn is the total time lag of the carrier Tri1 474-1, and Td=Td0−Tdyn is the time that the carrier wave Tri2 474-2 lags behind the carrier wave Tri1 474-1 after each compensation step.

The compensation block 685 seeks to eliminate the cross-circulating current by minimizing the difference between (IdiffBm1 and IdiffBm2). The compensation block 685 compares the difference between (IdiffBm1 and Idiffm2) to zero (0) at a summing junction 691. Specifically, the output of the summing junction 691 (691_output) is the quantity represented by Equation (9):

$$691 \_output = 0 - ( IdiffBm 2 - IdiffBm 1 ) . \qquad Equation ( 9 )$$

The output (691_output) of the summing junction 691 is provided to a block 692 that implements Equation (10):

$$\frac{\sqrt{3} {L}_{C S}}{6 {V}_{D C}} . \qquad Equation ( 10 )$$

The block 692 multiplies its input by the quantity represented by Equation (10) and provides the output to an adjustable gain block 693, which applies an adjustable gain. The adjustable gain may be greater than 0 and less than or equal to 1. The output of the adjustable gain block 693 is ΔTdyn, which is provided to a summing junction 694 and integrator 695 to determine Tdyn. The output of the integrator 695 (Tdyn) is fed back to the summing junction 694, which adds Tdyn to ΔTdyn to determine the total lag time of Tri1 compared to the original Tri1 after phase correction. The time delay (Td) is determined at a junction 696, which subtracts Tdyn from Td0 to determine the time delay (Td). The determined time delay (Td) is provided to a block 997, which multiples Td by the quantity represented in Equation (11):

$$- \frac{\sqrt{3} {L}_{C S}}{6 {V}_{D C}} . \qquad Equation ( 11 )$$

To provide a more specific example of the use of the compensation block 685, if the time delay before compensation (Td0) is 10 us and the switching frequency is 4 kHz, the compensation block 685 reduces this initial time delay of 10 us to nearly zero by calculating a new time delay (Td) value in each 4 kHz switching frequency period. The value of the time delay (Td) is reduced with each iteration and the carrier wave Tri1 474-1 and/or Tri2 474-2 delayed or advanced by Td. This process of iterating to reduce Td continues until the time delay (Td) is reduced to zero or nearly zero. In implementations in which the time delay (Td) is reduced to nearly zero, a threshold value of Td may be pre-defined and stored on the electronic storage 244. The compensation performed by the compensation block 685 results in the gate commands 471-b, 471-b being in phase and the gate commands 471-c, 471-c being in phase. In this way, the switches in each phase of the inverter 219-1 transition state at the same time as the corresponding switches in each phase of the inverter 219-2.

Referring again to FIG. 3A, the output of the switching frequency module 370 is Dabc1 and Dabc2, which are the reference waveforms for the inverter 219-1 and 219-2 respectively, and carrier waves Tri1 and/or Tri2. The carrier wave Tri1 and/or Tri2 is phase shifted by the compensation block 685 in the manner discussed above. The reference waveform Dabc1 and the carrier wave Tri1 from the module 370 are input to a PWM block 380-1. The reference waveform Dabc1 includes a reference for each phase a, b, c. The PWM block 380-1 generates gate commands 371-1 for each phase of the first inverter 219-1 by comparing each phase of the reference waveform Dabc1 to the carrier wave Tri1 as discussed above. The reference waveform Dabc2 and the carrier wave Tr2 from the module 370 are input into a PWM block 380-2. The PWM block 380-2 generates gate commands 371-2 for each phase of the second inverter 219-2 by comparing each phase of the reference waveform Dabc2 to the carrier wave Tri2. Because the carrier wave Tri1 and/or Tri2 have been phase shifted, when the respective resulting gate commands 371-1, 371-2 are applied to the respective inverters 219-1 and 219-2, the inverters 219-1 and 219-2 generate the target voltage and/or current for the load 202 and also reduces and/or eliminates the circulating currents in the power converters 210-1 and 210-2.

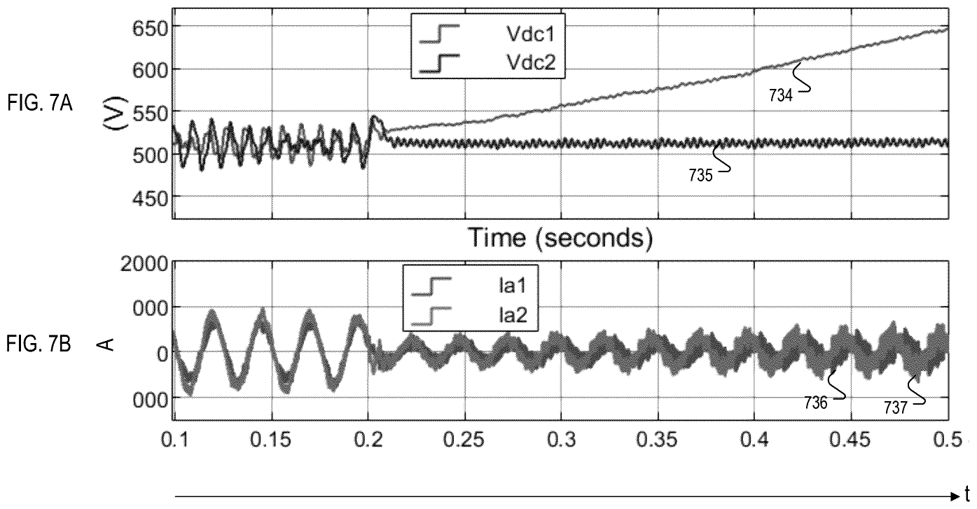

FIGS. 7A and 7B show simulated results without mitigation of circulating currents. In other words, the data shown in FIGS. 7A and 7B did not employ the control scheme 350. To produce the data shown in FIGS. 7A and 7B, a 750 KW, 380V, 4-pole induction motor (IM) platform with two paralleled ASDs at 500 HP (370 kW), 590A each was simulated. In the simulation, the first inverter carrier wave Tri1 lagged behind the second inverter carrier wave Tri2 by 10 microseconds (μs) without compensation. The two ASDs operated at 80% load and 80% rated IM speed. FIG. 7A shows the voltage 734 of the DC link of the first ASD and the voltage 735 of the DC link of the second ASD in voltage (V) as a function of time. FIG. 7B shows the output phase current 736 of the inverter of the first ASD and the output phase current 737 of the second ASD in amperes (A) over time. The time axis is in units of seconds and is the same for FIGS. 7A and 7B.

A step load was introduced from 80% to 15% at 0.2 s, causing the voltage (Vdc1) across the DC link in the first ASD to increase over time. The increase in Vdc can lead the DC link in the first ASD to fail prematurely. This is because at light load, the cross-circulating current at the inverter switching frequency is much larger than the load current. The cross-circulating current keeps charging the DC link capacitor bank of the first inverter while the rectifier diodes in the first inverter stop conducting.

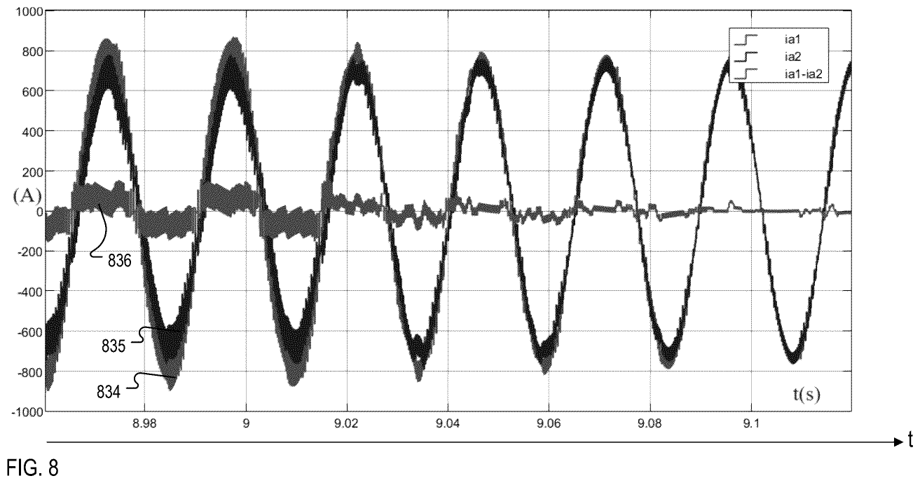

FIG. 8 shows a simulation of the same system but applying the control scheme 350 to compensate for circulating current, including the load operating frequency circulating current (mitigated by the module 360) and the carrier phase shift circulating current (mitigated by the module 370). FIG. 8 shows inverter output a-phase current in amperes (A) as a function of time in seconds(s) for the first ASD (834) and second ASD (835) and the difference between these output a-phase currents (836).

In the simulation that produced the data shown in FIG. 8, the 2 ASDs were operated at 80% load and 80% rated speed and without applying any circulating current mitigation solutions until 9 seconds(s). Under these conditions, the two ASD inverters experience unequal current amplitudes at both the load operating speed and at the inverter switching frequency due to the 10 μs phase delay or shift between the two ASD PWM carrier signals. The circulating current amplitude exceeded 100A.

At 9 s in the simulation, the modules 360 and 370 were applied to mitigate both circulating current (the currents at the load operating speed and the inverter switching frequency). As shown, beginning around 9.1 s (about 0.1 s after compensation was applied) the two ASD output currents share currents equally, the circulating current at either low or high frequency spectrums are nearly zero, demonstrating the effectiveness of the described circulating current compensation strategies. Moreover, although not shown, by reducing the circulating current, the voltage across the DC link of the first ASD does not increase in the manner shown in FIG. 7A. Instead, after the compensation, the voltage 734 across the DC link of the first ASD is substantially similar the voltage 735 across the DC link of the second ASD, and the DC link voltages of both ASDs remain nearly constant value over time. This is because, by compensating and mitigating for the circulating currents, the voltage across each of the two independent DC links becomes balanced and substantially equal.

These and other implementations are within the scope of the claims. For example, FIG. 2 shows a drive system 205 that includes two power converters 210-1 and 210-2 and the control system 240. However, the control system 240 and the control scheme 350 may be used to mitigate circulating currents in drive systems that include more than two parallel power converters each with an independent DC link.

What is claimed is:

1. A system comprising:
an adjustable speed drive (ASD) module comprising an input, an output, and a plurality of ASDs in parallel, each ASD comprising:
a rectifier electrically connected to the input of the ASD module;
an inverter electrically connected to the output of the ASD module, the inverter comprising a plurality of controllable switches configured to switch at a switching frequency; and
a direct current (DC) link electrically connected to the rectifier and the inverter; and
a control system coupled to the ASD module, the control system configured to compensate for a plurality of circulating currents.

2. The system of claim 1, wherein the plurality of circulating currents comprise a circulating current associated with the switching frequency and a circulating current associated with an operating speed of a load electrically connected to the ASD module.

3. The system of claim 2, wherein, to compensate for the circulating current associated with the switching frequency, the control system is configured to minimize a difference in an electrical quantity output by the inverter of each of the plurality of ASDs.

4. The system of claim 3, wherein the electrical quantity comprises a β-axis output current.

5. The system of claim 2, wherein, to compensate for the circulating current associated with the switching frequency, the control system is configured to adjust a phase of a carrier frequency of at least one of the inverters.

6. The system of claim 2, wherein, to compensate for the circulating current associated with the operating speed of the load, the control system is configured to minimize a difference in an observed o-axis current.

7. A control apparatus comprising:
a cross-circulating current compensation module configured to:
access a measured value of an electrical quantity at each of a plurality of inverters, wherein each of the plurality of inverters is electrically connected to an independent DC link;
determine a difference between the accessed measured values;
determine a compensation based on the determined difference; and
adjust a carrier wave of one or more of the plurality of inverters based on the determined compensation.

8. The control apparatus of claim 7, wherein, to determine a difference between the measured values, the cross-circulating current compensation module is configured to determine a difference between a β-axis component of an output current of each of the plurality of inverters.

9. The control apparatus of claim 7, wherein the compensation comprises a phase shift, and to adjust the carrier wave of one or more of the plurality of inverters, the cross-circulating current compensation module is configured to delay or advance the carrier wave of one or more of the plurality of inverters by the phase shift.

10. The control apparatus of claim 7, further comprising an operating frequency circulating current compensation module configured to reduce an amount of circulating current at an operating frequency of a load electrically connected to the plurality of inverters.

11. The control apparatus of claim 7, wherein the cross-circulating current compensation module is further configured to minimize the difference between the accessed measured values and to determine the compensation based on the minimized difference.

12. A method comprising:
accessing a measured value of an electrical quantity at an output of each of a plurality of inverters, wherein each of the plurality of inverters is electrically connected to an independent DC link;
determining a difference between the accessed measured values;
determining a compensation based on minimizing the difference between the accessed measured values;
adjusting a control signal for one or more of the plurality of inverters based on the compensation; and
providing the adjusted control signal to the one or more of the plurality of inverters to equalize the electrical quantity at the outputs of the inverters and the voltage across the independent DC links.

13. The method of claim 12, wherein the electrical quantity comprises a three-phase current at an output of each of the plurality of inverters, and, after providing the adjusted control signal to the one or more of the plurality of inverters, any one phase of the three-phase output current at a first one of the plurality of inverters is substantially the same in amplitude and phase as that same one phase at any other of the plurality of inverters.
